(19) United States
(12) Patent Application Publication
(10) Pub. No.: US 2004/0178462 A1
(43) Pub. Date: Sep. 16, 2004

(54) Semiconductor device and manufacturing method thereof

(76) Inventors: Hideaki Sakaguchi, Nagano-shi (JP); Mitsuhiro Aizawa, Nagano-shi (JP); Mitsutoshi Higashi, Nagano-shi (JP)

Correspondence Address: LADAS & PARRY, 224 SOUTH MICHIGAN AVENUE, SUITE 1200, CHICAGO, IL, 60604, US

(21) Appl. No.: 10/795,729

(22) Filed: Mar. 8, 2004

(30) Foreign Application Priority Data
Mar. 13, 2003 (JP) 2003-68178

(51) Int. Cl. G02B 6/12

(52) U.S. Cl. 257/432

(57) ABSTRACT

A semiconductor device including a substrate and a lens panel that is fixed to an upper surface of the substrate with bumps is provided. An optical transmitter is fixed to the bottom surface of the substrate with bumps and a transparent resin material. Metal films are formed on the upper and bottom surfaces of the substrate at points where the bumps for fixing the lens panel or the optical transmitter connect with the substrate. In the manufacturing process of the semiconductor device, adjustment operations are performed for arranging the optical axes of lens portions of the lens panel to be coaxial with the optical axes of laser diodes of the optical transmitter. The lens panel may be connected to the metal film formed on the upper surface of the substrate by propagating an ultrasonic wave to the bumps implemented between the lens panel and the substrate when alignment marks of the lens panel and alignment marks of the substrate correspond. In this way, the lens panel may be protected from being stained with adhesive material, for example, and optical axis position adjustment may be easily realized with high accuracy.

### BACKGROUND OF THE INVENTION

1. Field of the Invention

The present invention relates generally to a semiconductor device and a manufacturing method thereof, and particularly to a semiconductor apparatus in which an optical component (lens) is arranged to be positioned opposite a semiconductor element that realizes photo-electro conversion or electro-photo conversion.

2. Description of the Related Art

In an optical fiber communication system, a semiconductor device such as a photo-electro conversion module and an electro-photo conversion module is used. The photo-electro conversion module implements a semiconductor element (optical receiver) that converts an optical signal from optical fibers into an electric signal, and the electro-photo conversion module implements a semiconductor element (optical transmitter) that converts an electric signal into an optical signal.

The photo-electro conversion module includes a substrate on which the optical receiver is mounted, a lens panel implementing an optical receiver lens that guides light from the optical fibers to the optical receiver, and an optical fiber holding unit that holds the optical fibers. The electro-photo conversion module includes a substrate on which the optical transmitter is mounted, a lens panel implementing an optical transmitter lens that guides light from the optical transmitter to the optical fibers, and an optical fiber holding unit that holds the optical fibers.

Also, in a semiconductor device that is connected to optical fibers, the lens panel (optical receiver lens or optical transmitter lens) is implemented between the optical fibers and the semiconductor element (optical receiver or optical transmitter). In such case, it is important to accurately adjust the mount position of the lens panel with respect to the optical receiver or the optical transmitter.

In the prior art, for example, Japanese Patent Laid-Open Publication No. 2002-198502 discloses a device in which an optical element (e.g., optical receiver, or optical transmitter) is mounted on a substrate in a manner such that the optical portion of the optical element is arranged to be directed to a through hole of the substrate into which a light-transmissive member (lens) is fit, and an adhesive and a light-transmissive underfill material are inserted between the substrate and the optical element, and between the light-transmissive member and the optical element.

In this device, the optical element is connected to a wiring pattern of the substrate via bumps, and solder balls are implemented on the wiring pattern as external terminals.

In the process of mounting the optical component onto the substrate, the space between the optical portion of the optical element and the light-transmissive member is controlled by means of a spacer, and after the optically functioning portion is optimally positioned with respect to the light-transmissive member, the bumps of the optical element are fixed to the wiring pattern.

FIG. 1 shows a configuration of another exemplary semiconductor device according to the prior art. It is noted that the semiconductor device 10 of FIG. 1 represents an exemplary electro-photo conversion module that converts an electric signal into an optical signal.

The semiconductor device 10 includes a substrate 12 on which an optical transmitter 14 corresponding to a semiconductor element is mounted. On the upper side of the optical transmitter 14, laser diodes (LD) 14a that may correspond to VCSELs (Vertical Cavity Surface Emitting Laser), for example, are implemented; Also, solder balls 18 are implemented at the bottom surface of the substrate 12 at predetermined pitches.

A case 20 is mounted on the substrate 12, and an opening 22 formed at the top portion of the case 20 that is positioned opposite the optical transmitter 14 accommodates a lens 24. Also, a socket 30 is mounted on the case 20, and an end of an optical fiber cable 26 is fixed to the socket 30.

Optical fibers 28 run through the optical fiber cable 26, and the lens 24 includes lens portions 24a that are coaxial to the ends of the optical fibers 28. The socket 30 is fixed to the case 20 by means of fixing members 32 that are fixed to the upper surface of the case 20.

In the following, a manufacturing process for manufacturing the semiconductor device 10 is described.

\mathring{1} In step 1, the optical transmitter 14 is mounted on the substrate 12, and the wiring of the substrate 12 and the optical transmitter 14 are connected by a bonding wire 16.

\mathring{2} In step 2, the lens 24 is fit into the opening 22 of the case 20 and is fixed thereto with adhesive.

\mathring{3} In step 3, a current is supplied to the optical transmitter 14 to induce light emission, and the optical axes of the lens portions 24a of the lens 24 and the optical axes of the laser diodes (LD) 14a of the optical transmitter 14 are adjusted to be coaxial. This adjustment process is realized by moving the case 20 with respect to the substrate 12 to an optimal position.

\mathring{4} In step 4, when the case 20 is optimally positioned, it is fixed to the substrate 12.

\mathring{5} In step 5, the optical fibers are fixed to the case 20.

Japanese Patent Laid-Open Publication No.2002-198502 discloses a manufacturing method of fixing bumps to a wiring pattern of a substrate and fixing the optical element (e.g., optical receiver or optical transmitter) thereon, after which an underfill material is inserted between the optical element and the substrate. In such case, when the underfill material is applied to the surface of the light-transmissive member (lens) that is fit to the substrate, the lens portions of the light-transmissive member may be stained thereby causing a change in the transparency characteristics of the lens.

As for the semiconductor device 10 of FIG. 1, in step 3, upon positioning the case 20 with respect to the substrate 12, active alignment needs to be conducted wherein light is irradiated while adjustment of the optical axes of the lens 24 implemented in the case 20 and the optical transmitter 14 are performed.

However, in order to adjust the optical axes of the lens portions 24a of the lens 24 to be coaxial with the optical axes of the laser diodes (LD) 14a, the entire case 20 needs to be moved, and thereby, the position adjustment cannot be performed very easily. Thus, accurate positioning of the case 20 tends to take time and effort.

### SUMMARY OF THE INVENTION

The present invention has been conceived with due respect to one or more problems of the related art, and its object is to provide a semiconductor device in which an optical component is positioned and fixed using bumps so that accurate positioning of the optical component may be realized without staining the optical component. Another object to the present invention is to provide a method of manufacturing such a semiconductor device.

According to an aspect of the present invention, a semiconductor device includes a semiconductor element that performs photo-electro conversion or electro-photo conversion, a substrate on which the semiconductor element is mounted, an optical component that controls light incident on the semiconductor element or light emitted from the semiconductor element, and a bump that fixes the optical component to the substrate. By implementing a bump for fixing the optical component to the substrate, the optical component may be fixed to the substrate while conducting position adjustment of the optical component, thereby realizing accurate positioning of the optical component, and the optical component may be mounted without having to use adhesive, for example, that may possibly stain the optical component.

In one embodiment of the present invention, an optical component may correspond to a lens. Accordingly, a lens may be fixed to a substrate while conducting position adjustment thereof to realize accurate positioning of the lens and to prevent staining of the lens by adhesive, for example.

In another embodiment of the present invention, a bump may correspond to a gold bump. Accordingly, the optical component may be positioned and fixed to the substrate without having to use solder paste, for example, so that accurate positioning of the optical component may be realized while preventing the optical component from being stained by the solder paste.

In another embodiment of the present invention, a semiconductor device may include a first metal film that is formed on the substrate at a connection point between the bump and the substrate, and a second metal film that is formed on the optical component at a connection point between the bump and the optical component. Accordingly, a gold bump may be used to realize accurate positioning of the optical component, and a metal film may be used to prevent staining of the optical component by solder paste, for example.

In another embodiment of the present invention, a case that is adapted to accommodate an optical fiber may be mounted on the substrate. Accordingly, the semiconductor element may accurately receive an optical signal from an optical fiber, or an optical signal emitted from the semiconductor element may be accurately output to an optical fiber.

In another embodiment of the present invention, a semiconductor device may include a first alignment mark that is formed on the substrate, and a second alignment mark that is formed on the optical component. Accordingly, relative positioning of the substrate and the optical component may be accurately adjusted.

According to another aspect of the present invention, a semiconductor device may include a semiconductor element that performs photo-electro conversion or electro-photo conversion, a substrate on which the semiconductor element is mounted, an optical component that controls light incident on the semiconductor element or light emitted from the semiconductor element, and a bump that fixes the optical component to the semiconductor element. By implementing a bump for fixing the optical component to the semiconductor element, the optical component may be fixed to the semiconductor element while conducting position adjustment of the optical component, thereby realizing accurate positioning of the optical component, and the optical component may be mounted onto the semiconductor element without being stained by adhesive, for example.

In one embodiment of the present invention, an optical component may correspond to a lens. Accordingly, a lens may be fixed to the semiconductor element while conducting position adjustment of thereof to realize accurate positioning of the lens and prevent staining of the lens by adhesive, for example.

In another embodiment of the present invention, a bump may correspond to a gold bump. Accordingly, the optical component may be positioned and fixed to the semiconductor element without having to use solder paste, for example, so that accurate positioning of the optical component may be realized while preventing the optical component from being stained by the solder paste.

In another embodiment of the present invention, a semiconductor device may include a first metal film that is formed on the semiconductor element at a connection point between the bump and the semiconductor element, and a second metal film that is formed on the optical component at a connection point between the bump and the optical component. Accordingly, a gold bump may be used to realize accurate positioning of the optical component, and a metal film may be used to prevent staining of the optical component by solder paste, for example.

In another embodiment of the present invention, a case that is adapted to accommodate an optical fiber may be mounted on the substrate. Accordingly, the semiconductor element may accurately receive an optical signal from an optical fiber, or an optical signal emitted from the semiconductor element may be accurately output to an optical fiber.

In another embodiment of the present invention, a semiconductor device may include a first alignment mark that is formed on the semiconductor element, and a second alignment mark that is formed on the optical component. Accordingly, relative positioning of the semiconductor element and the optical component may be accurately adjusted.

According to another aspect of the present invention, there is provided a method of manufacturing a semiconductor device that includes a substrate on which a semiconductor element that performs photo-electro conversion or electro-photo conversion is mounted, and an optical component that controls light incident on the semiconductor element or light emitted from the semiconductor element, the method including an optical component mounting step of mounting the optical component on the substrate implementing the semiconductor element that includes forming a first alignment mark and a first metal film on the substrate, forming a second alignment mark and a second metal film on the optical component, placing a bump on one of the first metal film and the second metal film, positioning the optical component to a mount position on the substrate based on the first alignment mark and the second alignment mark, and fixing the optical component to the substrate by connecting the bump with the first metal film and the second metal film using an ultrasonic wave. Accordingly, position adjustment of the optical component may be conducted while fixing the optical component to the substrate in the mounting step, to thereby realize accurate positioning of the optical component, and the optical component may be mounted to the substrate without having to use adhesive, for example, that may possibly stain the optical component.

According to another embodiment of the present invention, there is provided a method of manufacturing a semiconductor device that includes a semiconductor element that performs photo-electro conversion or electro-photo conversion, and an optical component that controls light incident on the semiconductor element or light emitted from the semiconductor element, the method including an optical component mounting step of mounting the optical component on the semiconductor element that includes forming a first alignment mark and a first metal film on the semiconductor element, forming a second alignment mark and a second metal film on the optical component, placing a bump on one of the first metal film and the second metal film, positioning the optical component to a mount position on the semiconductor element based on the first alignment mark and the second alignment mark, and fixing the optical component to the semiconductor element by connecting the bump with the first metal film and the second metal film using an ultrasonic wave. Accordingly, position adjustment of the optical component may be conducted while fixing the optical component to the semiconductor element in the mounting step, to thereby realize accurate positioning of the optical component, and the optical component may be mounted to the semiconductor element without having to use adhesive, for example, that may possibly stain the optical component.

### BRIEF DESCRIPTION OF THE DRAWINGS

FIG. 1 shows a longitudinal cross-sectional view of a semiconductor device according to the prior art;

FIG. 2 shows a longitudinal cross-sectional view of a semiconductor device according to a first embodiment of the present invention;

FIG. 3 shows a perspective view of a lens panel viewed from an upper diagonal direction;

FIG. 4 shows a perspective view of the lens panel viewed from a lower diagonal direction;

FIGS. 5A˜5C are cross-sectional views of an exemplary process of forming bumps on a lens panel that is made of quartz;

FIGS. 6A˜6C are cross-sectional views of another exemplary process of forming bumps on the lens panel made of quartz;

FIG. 7 shows a perspective view of a substrate;

FIG. 8 shows a longitudinal cross-sectional view of the substrate of FIG. 7;

FIG. 9 is a cross-sectional view of a process of mounting a lens panel and an optical transmitter on the substrate of FIG. 7;

FIG. 10 is a cross-sectional view of the process of mounting the lens panel and the optical transmitter on the substrate continued from FIG. 9;

FIG. 11 shows a longitudinal cross-sectional view of a semiconductor device according to a second embodiment of the present invention;

FIG. 12 shows a longitudinal cross-sectional view of a semiconductor device according to a third embodiment of the present invention;

FIG. 13 shows longitudinal cross-sectional views of a semiconductor device according to a fourth embodiment of the present invention; and

FIG. 14 shows a longitudinal-cross-sectional view of a semiconductor device according to a fifth embodiment of the present invention.

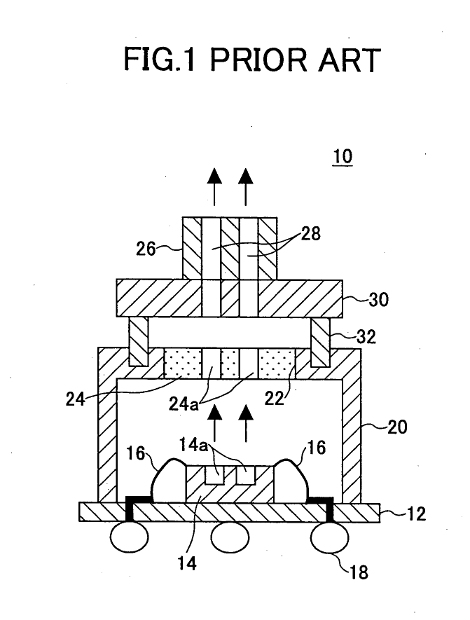

### DETAILED DESCRIPTION OF THE PREFERRED EMBODIMENTS

In the following, preferred embodiments of the present invention are described with reference to the accompanying drawings.

It is noted that in the following, preferred embodiments of an electro-photo conversion module that converts an electric signal into an optical signal are described as illustrative applications of a semiconductor device according to the present invention.

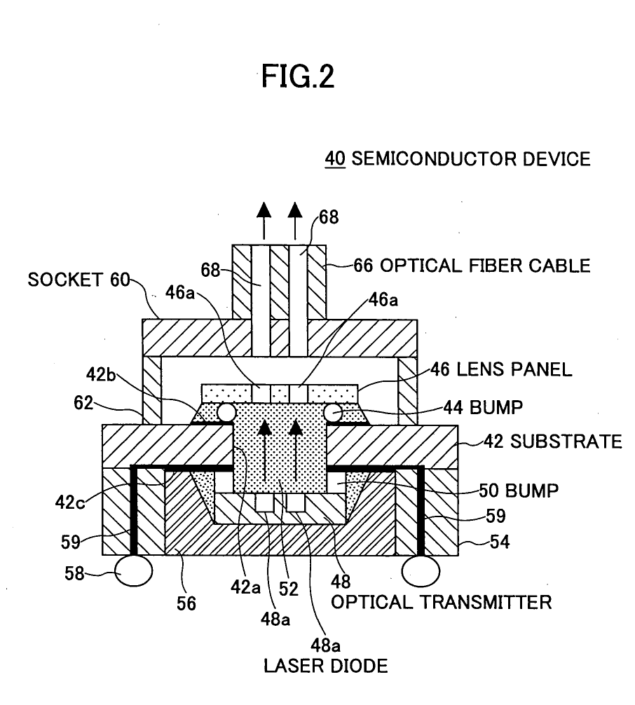

FIG. 2 shows a longitudinal cross-sectional view of a semiconductor device according to a first embodiment of the present invention.

As is shown in FIG. 2, the semiconductor device 40 according to the present embodiment includes a substrate 42 on which a lens (optical component) 46 is mounted via bumps 44. The lens panel 46 corresponds to a flat panel that includes lens portions 46a formed around the center region of the panel.

An optical transmitter 48 is fixed to the bottom surface of the substrate 42 via bumps 50 and a transparent resin material 52. The optical transmitter 48 includes laser diodes (LD) 48a that emit light when an electric current is applied thereto. The substrate 42 has a through hole 42a at its center region, and the lens portions 46a of the lens panel 46 and the laser diodes 48a of the optical transmitter 48 face each other via the through hole 42a.

At the upper and bottom surfaces of the substrate 42, first and second metal films 42b and 42c are implemented, and the bumps 44 and 50 are connected to the substrate 42 via the first and second metal films 42b and 42c, respectively.

At the bottom surface of the substrate 42, a support member 54 surrounding the optical transmitter 48, and a sealing member 56 made of thermal conductive resin that is filled into a space (cavity portion) created by the support member 54 surrounding the optical transmitter 48 are formed. At the bottom surface of the support member 54, solder balls 58 are implemented as external connection terminals. The solder balls 58 are connected to through holes 59 that correspond to wiring that extends in up-down directions along the support member 54.

On the upper surface of the substrate 42, a socket 60 is formed over the lens panel 46 and fixed thereto. The socket 60 is mounted over the lens panel 46 via fixing members 62 that are fixed to the upper surface of the substrate 42 so that the socket 60 does not come into direct contact with the lens panel 46. Also, the transparent resin material 52 that supports the lens panel 46 fixed to the substrate 42 is inserted into the through hole 42a of the substrate 42.

An optical fiber cable 66 is fixed to the socket 60, and optical fibers 68 running through the cable 66 are exposed at the socket 60. The ends of the optical fibers 68 being exposed are arranged to face the lens portions 46a of the lens panel 46 so that the optical fibers 68 can receive light emitted from the optical transmitter 48.

As is described below, in the manufacturing process of the semiconductor device according to the present embodiment, adjustment operations are performed in order to arrange the optical axes of the lens portions 46a of the lens panel 46 to be coaxial with the optical axes of the laser diodes (LD) 48a of the optical transmitter 48. In this operation, an ultrasonic wave is propagated to the bumps 44 when alignment marks of the lens panel 46 and alignment marks of the substrate 42 correspond, and in this way the bumps may be optimally connected to the metal film 42b of the substrate 42.

By implementing the bumps 44 for realizing the connection, the lens panel 46 may be prevented from being stained by adhesive material, for example, and active alignment of moving the entire case implementing the lens while irradiating light need not be performed as in the conventional art. Thereby, position adjustment of the lens panel 46 (optical component) may be easily realized, and alignment of the optical axes may be performed with accuracy and precision.

In the following, exemplary configurations of the lens panel 46 are described.

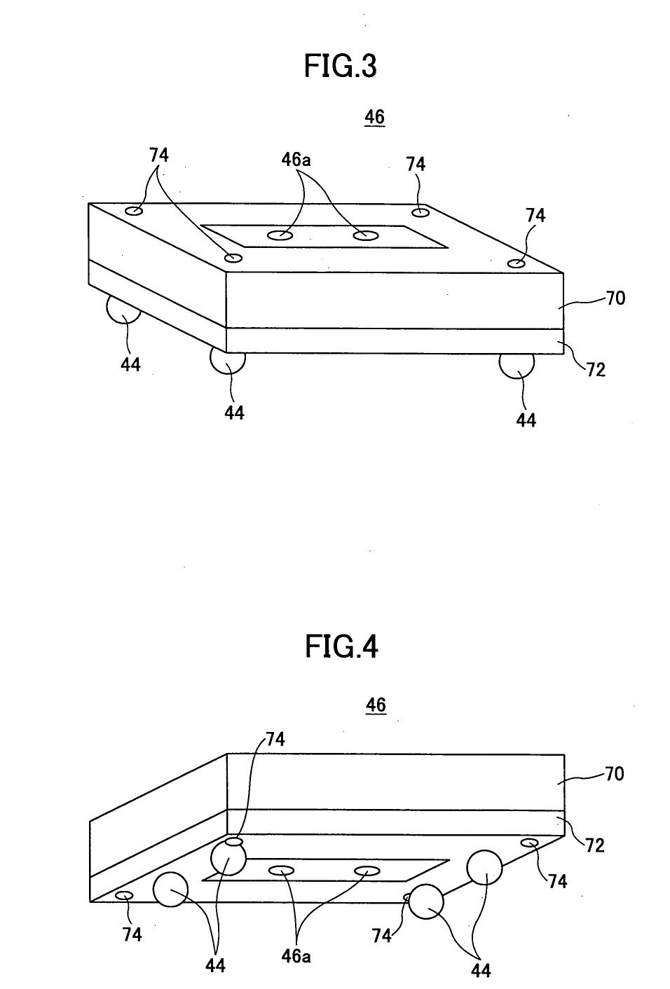

FIGS. 3 and 4 are diagrams illustrating an exemplary configuration of the lens panel 46 that is made of resin material.

FIG. 3 shows a perspective view of the lens panel 46 as seen from an upper diagonal direction. FIG. 4 shows a perspective view of the lens panel 46 as seen from a lower diagonal direction.

As is shown in the drawings, the lens 46 includes a resin layer 70 that is made of transparent resin material and is formed using a metal resin mold, a second metal film 72 that is laminated on the bottom surface of the resin layer 70, bumps 44 that are implemented on the surface of the metal film 72, and lens portions 46a formed at the center portion of the resin layer 70.

The metal film 72 is formed into a rectangular frame so that it does not cover the lens portions 46a. As for the material of the metal film 72, an aluminum foil or an aluminum sheet may be used.

In the formation process of the lens panel 46, the metal film 72 is injected into the metal resin mold after which molten resin is injected so that the metal film 72 may adhere to the bottom surface of the resin layer 70. Then, the bumps 44 are bonded to the surface of the metal film 72 at the four corners of the rectangular molded resin layer-metal film unit through Au (gold) ball bonding.

At the respective four corners of the upper and bottom surfaces of the resin layer-metal film unit, second alignment marks 74 are implemented for realizing mount position adjustment of the lens panel 46.

In another exemplary configuration, the lens panel 46 may be made of quartz rather than resin.

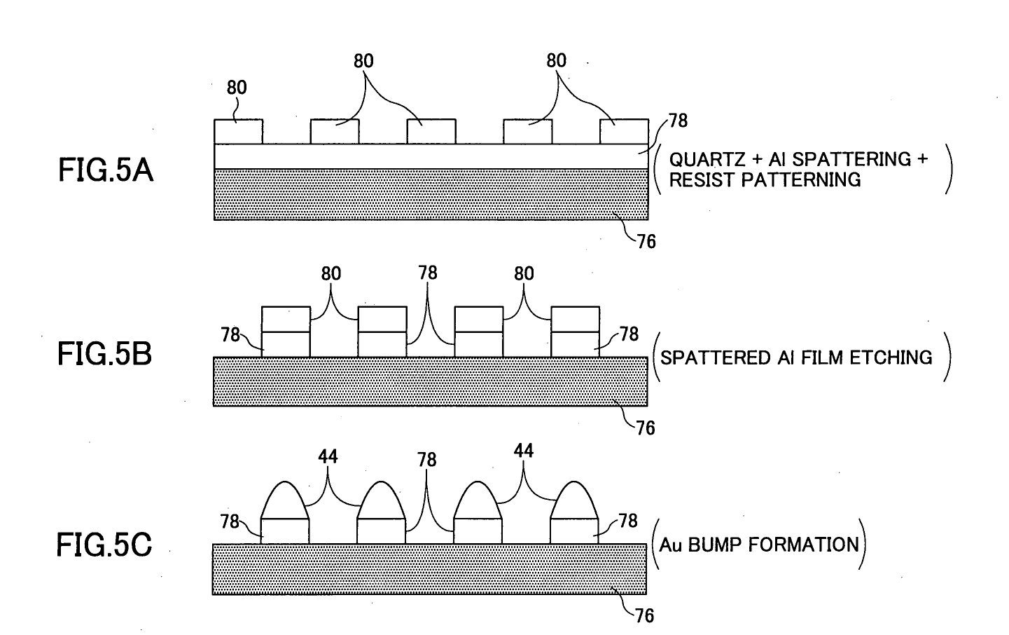

FIGS. 5A˜5C illustrate an exemplary process (manufacturing method) of implementing the bumps 44 onto the lens panel 46 made of quartz.

In step 1, masking is performed on the center region of a quartz layer 76 on which the lens portions 46a are to be formed.

In step 2, Al (aluminum) is spattered on the surface of the panel-shaped quartz layer 76 using a vapor deposition apparatus or a spattering apparatus to thereby form an Al film 78, as is shown in FIG. 5A.

In step 3, resist patterning is performed in which resists 80 are formed on the surface of the deposed or spattered Al film 78 at positions on which the bumps 44 are to be formed.

In step 4, etching of the Al film 78 is performed so that the Al film 78 is removed from the areas on which the resists 80 are not formed, as is show in FIG. 5B.

In step 5, the resists 80 covering the Al film 78 remaining on the quartz layer 76 are removed.

In step 6, Au bumps 44 are formed on the surface of the Al film 78 after the resists 80 are removed therefrom, as is shown in FIG. 5C. The bumps 44 may be formed using a wire bonding apparatus (not shown). It is noted that in FIGS. 2-4, the bumps 44 are illustrated as having ball-shaped configurations; however, when the bumps 44 are formed through wire bonding, they may actually have curved surface configurations as is shown in FIG. 5C.

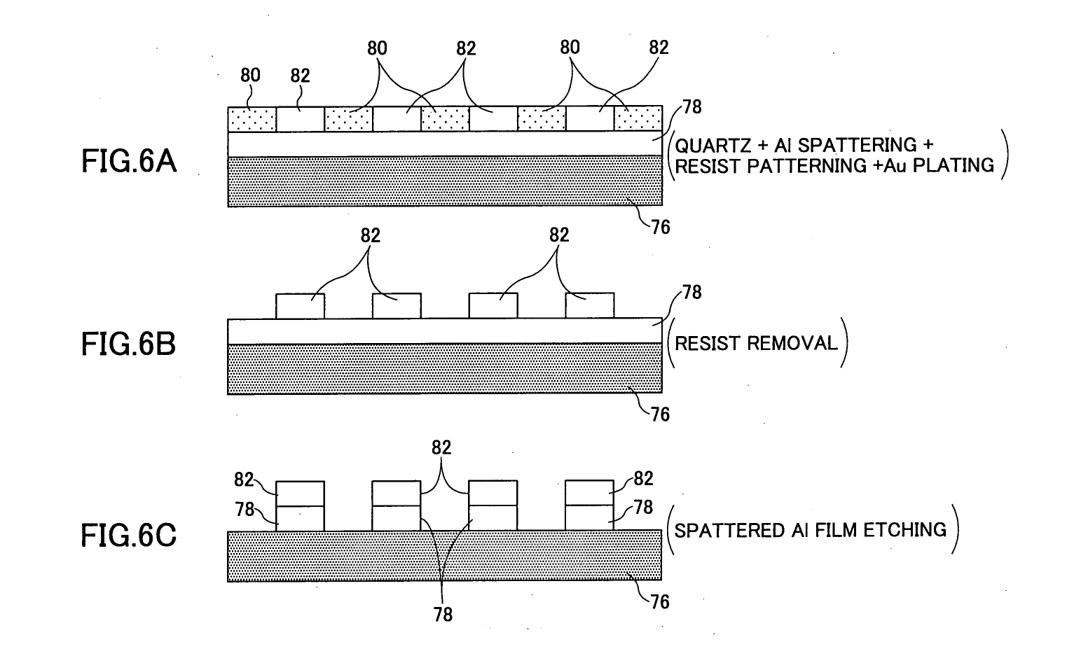

FIGS. 6A˜6C illustrate a variation of the process (manufacturing method) of implementing the bumps 44 onto the surface of the lens panel 46 made of quartz.

In step 1, masking is performed on the center region of the quartz layer 76 where the lens portions 46a are to be formed.

In step 2, the Al film 78 is formed on the surface of the panel-shaped quartz layer 76 using a vapor deposition apparatus or a spattering apparatus as is shown in FIG. 6A.

In step 3, resist patterning is performed in which the resists 80 are formed on areas of the spattered or deposed Al film 78 surface on which the bumps 44 are not to be implemented.

In step 4, the quartz layer 76 is immersed in a plating tank (not shown) to form Au plating films 82 on areas of the Al film 78 surface on which the resists 80 are not formed.

In step 5, the resists 80 are removed, as is shown in FIG. 6B.

In step 6, etching of the Al film 78 is performed so that portions of the Al film 78 that are not covered by the Au plating films 82 are removed, as is shown in FIG. 6C. In this way, bumps 44 made of the Au plating films 82 are formed.

In order to strengthen adherence between the quartz layer 76 and the Au plating film 82, a metal film made of Cr (chromium), Ti (titanium), TiW (titanium-tungsten alloy) Ta (tantalum), NiCr (nickel-chromium), Fe (iron), Ag (silver), Co (cobalt), or Nb (niobium), for example, may be formed on the surface of the quartz layer 76 instead of the Al film 78.

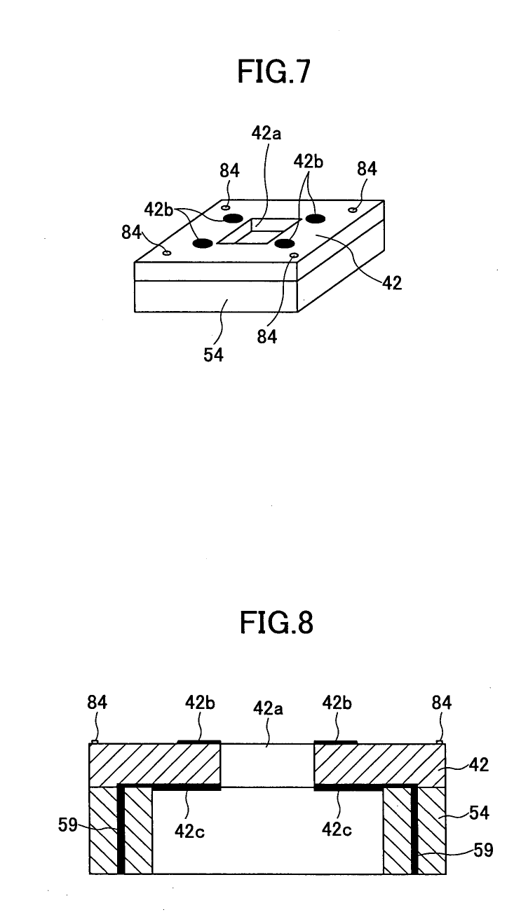

In the following, a configuration of the substrate 42 is described with reference to FIGS. 7 and 8.

As is shown in FIG. 7, the substrate 42 corresponds to a flat board having a rectangular through hole 42a formed at its center portion to enable light emitted from the optical transmitter 48 to pass through the substrate 42 via the through hole 42a. On the upper surface of the substrate 42, the first metal film 42b is formed for connecting the bumps 44 to the substrate 42 at the four corners of the rectangular through hole 42b. First alignment marks 84 are also formed on the upper surface of the substrate 42 at the four corners positioned further outward from the connection points of the bumps 44.

Accordingly, in mounting the lens panel 46 onto the substrate 42, the position of the lens panel 46 may be adjusted so that the second alignment marks 74 (see FIG. 4) of the lens panel 46 and the first alignment marks 84 of the substrate 42 correspond, and in turn, the optical axis of the lens panel 46 may be optimally positioned.

At the bottom surface of the substrate 42 surrounding the through hole 42a, the second metal film 42c is formed for connecting the bumps 50 of the optical transmitter 48 to the substrate 42. Also, the support member 54 formed into a rectangular frame surrounding the optical transmitter 48 is mounted on the bottom surface of the substrate 42. It is noted that in mounting the optical transmitter 48 on the substrate 42, the positioning of the optical transmitter 48 may be optimally adjusted by arranging alignment marks provided at the optical transmitter 48 (not shown) to correspond to alignment marks provided at the bottom surface of the substrate 42 (not shown) so that the optical axis of the optical transmitter 48 may be accurately set.

In the following, a process of implementing the optical component and semiconductor element of the semiconductor device 40 is described.

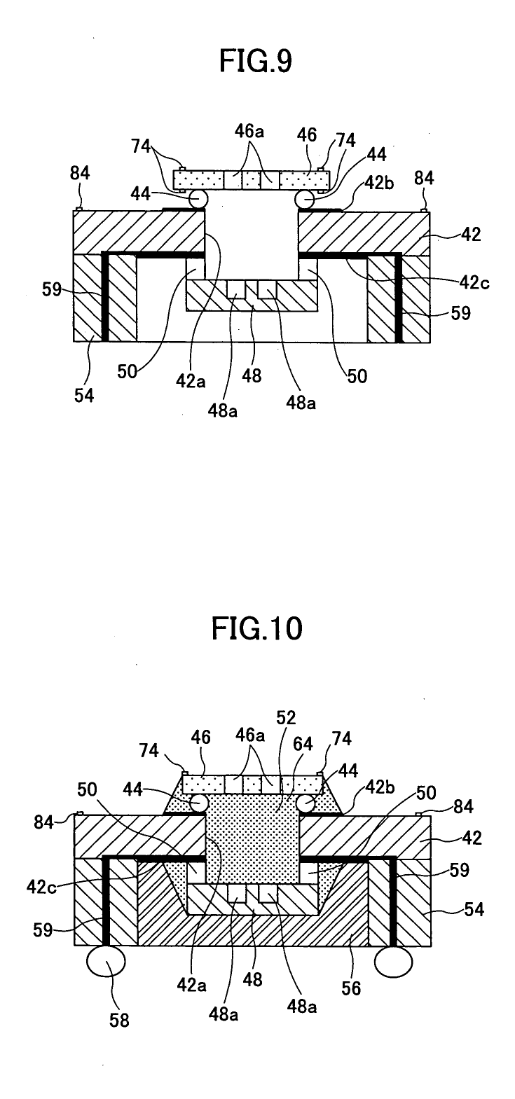

FIGS. 9 and 10 illustrate the process of mounting the lens panel 46 and the optical transmitter 48 to the substrate 42.

First, a mount process performed in a case where the lens panel 46 is made of quartz is described.

As is shown in FIG. 9, the bumps 50 provided for mounting the optical transmitter 48 are connected to the second metal film 42c that is formed on the substrate 42, and in this state, an ultrasonic wave is propagated to the bumps 50 so that the optical transmitter 48 may be fixed to the bottom surface of the substrate 42. In this process, the position of the optical transmitter 48 is adjusted by arranging the alignment marks of the optical transmitter 48 to correspond to the alignment marks provided at the bottom surface of the substrate 42 so that the optical axis of the optical transmitter 48 may be accurately set. Then, a driver (not shown) and a chip capacitor (not shown) may be mounted, for example.

Then, the bumps 44 provided for mounting the lens panel 46 are connected to the first metal film 42b that is formed on the substrate 42, and in this state, an ultrasonic wave is propagated to the bumps 44 so that the lens panel 46 may be fixed to the upper surface of the substrate 42. In this process, the position of the lens panel 46 is adjusted by arranging the alignment marks 74 of the lens panel 46 to correspond to the alignment marks 84 of the substrate 42.

When the process of adjusting the optical axis of the lens panel 46 is completed, an ultrasonic wave is propagated so that the bumps are fixed to the first metal film 42b on the substrate 42.

Then, as is illustrated in FIG. 10, the transparent resin material 52 is inserted between the lens panel 46 and the optical transmitter 48 and the through hole 42a is sealed.

Then, the sealing member 56 made of thermal conductive resin is filled in the space (cavity portion) that is created by the support member 54 inside which space the optical transmitter 48 is mounted, and the bottom portion of the optical transmitter is also sealed. Then, the solder balls 58 corresponding to external connection terminals are positioned at the bottom surface of the support member 54.

Then, as is shown in FIG. 2, the fixing members 62 of the socket 60 are fixed to the upper surface of the substrate 42 with adhesive, for example.

In a case where the lens panel 46 is made of resin, the lens panel 46 has low thermal resistance, and thereby a process that differs from that described above is performed.

First, the step of implementing the solder balls 58 corresponding to external connection terminals is performed. Then, the optical transmitter 48 is fixed to the substrate 42 via the bumps 50, and elements such as the driver and chip capacitor are mounted on the substrate 42 to realize wire connection.

Then, the bumps 44 are connected to the first metal film 42b of the substrate 42, and in this state, position adjustment of the lens panel 46 is performed. Then, when the alignment marks 74 of the lens panel 46 and the alignment marks 84 of the substrate 42 correspond, an ultrasonic wave is propagated so that the bumps 44 may be fixed to the first metal film 42b on the substrate 42.

Then, the transparent resin material 52 is inserted between the lens panel 46 and the optical transmitter 48 so that the through hole 42a is sealed.

Then, the optical transmitter 48 is mounted, and the space (cavity portion) created by the support member 54 surrounding the optical transmitter 48 is filled with the sealing member 56 made of thermal conductive resin so that the bottom portion of the optical transmitter 48 is sealed.

Then, as is shown in FIG. 2, the fixing members 62 of the socket 60 are fixed to the upper surface of the substrate 42 with adhesive, for example.

As is described above, in the case where the lens panel is made of resin, the solder balls 58 are mounted on the substrate before mounting the lens panel 46 so that the lens may be protected from being deformed.

In the following, a semiconductor device according to a second embodiment of the present invention is described. It is noted that the components of the second embodiment that are identical to those of the first embodiment are assigned the same numerical references and their descriptions are omitted.

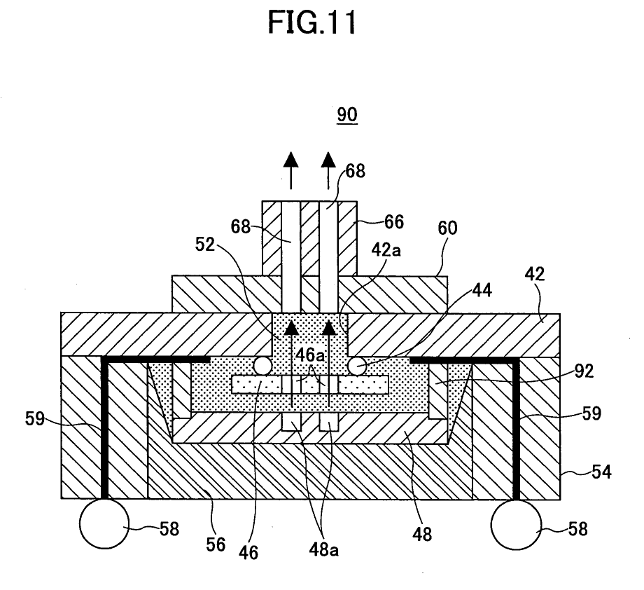

FIG. 11 shows a longitudinal cross-sectional view of the semiconductor device according to the second embodiment.

As is shown in FIG. 11, in the semiconductor device 90 of the second embodiment, the lens panel 46 is fixed to the bottom surface of the substrate 42 via bumps 44 using an ultrasonic wave. On the upper surface of the substrate 42, the socket 60 is directly mounted.

The optical transmitter 48 is positioned below the lens panel 46. The optical transmitter 48 is fixed to the bottom surface of the substrate 42 via support pillars 92 corresponding to pillar-shaped bumps made of gold plating that can also realize electrical connection of the optical transmitter 48.

According to this arrangement, since both the lens panel 46 and the optical transmitter 48 are implemented below the substrate 42, the distance between the lens panel 46 and the optical transmitter 48 may be reduced compared to the first embodiment, and thereby, adjustment of the optical axes of the lens panel 46 and the optical transmitter 48 may be made easier.

In the following, a semiconductor device according to a third embodiment of the present invention is described. It is noted that the components of the third embodiment that are identical to those of the first and second embodiments are given the same numerical references and their descriptions are omitted.

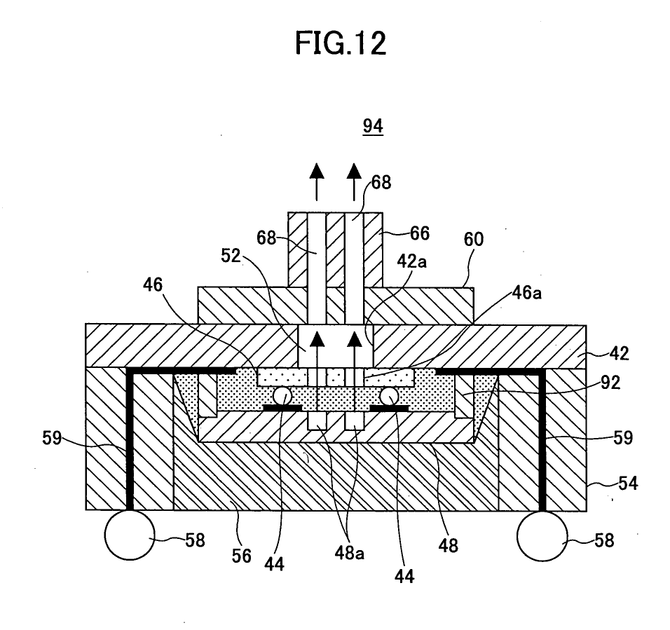

FIG. 12 shows a longitudinal cross-sectional view of the semiconductor device according to the third embodiment.

As is shown in FIG. 12, in the semiconductor device 94 of the third embodiment, the optical transmitter 48 is fixed to the bottom surface of the substrate 42 via the support pillars 92, and the socket 60 is directly mounted on the upper surface of the substrate 42.

The lens panel 46 is positioned above the optical transmitter 48. Specifically, the lens panel 46 is mounted on the upper surface of the optical transmitter 48 via the bumps 44 and connected thereto by means of an ultrasonic wave, and at the same time, the lens panel 46 is directly connected to the bottom surface of the substrate 42. According to this arrangement, the adjustment of the optical axis of the lens panel 46 is conducted while fixing the lens panel 46 to the optical transmitter 48.

In the present embodiment, since the lens panel 46 is fixed to the optical transmitter 48, the optical axis adjustment may be performed prior to fixing the elements to the substrate 42, and thereby, the optical axis adjustment may be performed with greater accuracy.

It is noted that also in the third embodiment, the lens panel is mounted directly onto the bottom surface of the substrate 42, and thereby, the through hole 42a of the substrate 42 may be sealed by the socket 60 and the lens panel 46. Thus, the through hole 42a is not filled with the transparent resin material in this embodiment.

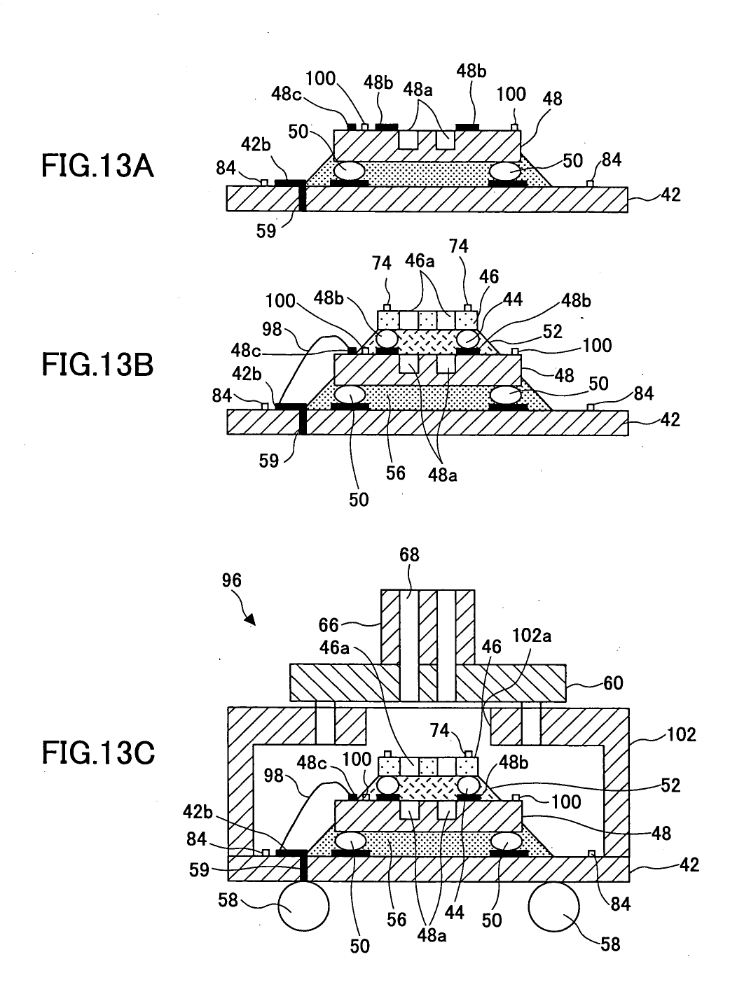

In the following, a semiconductor device according to a fourth embodiment of the present invention is described with reference to FIGS. 13A˜13C. It is noted that the components of the fourth embodiment that are identical to the previous embodiments are given the same numerical references and their descriptions are omitted.

In the semiconductor device 96 of the fourth embodiment, first, the optical transmitter 48 is fixed to the upper surface of the substrate 42 via the bumps 50 using ultrasonic wave, as is shown in FIG. 13A. Then, the sealing member 56 made of thermal conductive resin is inserted between the bottom surface of the optical transmitter 48 and the substrate 42.

Then, a metal film 48c formed on the optical transmitter 48 and the metal film 42b formed on the substrate 42 are connected with a wire 98, as is shown in FIG. 13B. Then, the lens panel 46 is fixed to the upper surface of the optical transmitter 48 via the bumps 44 by means of an ultrasonic wave. It is noted that in the present embodiment, the bumps 50 are provided for realizing mechanical connection, and electrical connection of the optical transmitter 48 and the substrate 42 is realized by the wire 98.

In mechanically connecting the lens panel 46 and the optical transmitter 48, an ultrasonic wave is propagated to fix the bumps 44 to the metal film 48b of the optical transmitter 48 when the alignment marks 74 of the lens panel 46 and alignment marks 100 of the optical transmitter 48 correspond.

Then, the transparent resin material 52 is inserted between the lens panel 46 and the optical transmitter 48. Then, a case 102 and external terminals are fixed to the substrate and the socket 60 is fixed to the upper surface of the case 102, as is shown in FIG. 13C.

At the center portion of the case 102, a through hole 102a is formed. The lens portions 46a of the lens panel 46 are directed to the ends of the optical fibers 68 via the through hole 102a and are arranged to output optical signals to the optical fibers 68.

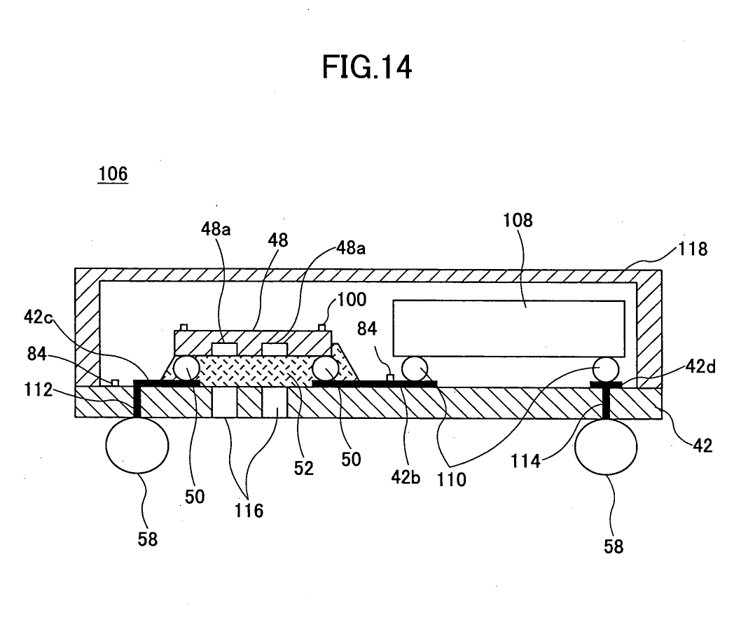

In the following, a semiconductor device according to a fifth embodiment of the present invention is described with reference to FIG. 14. It is noted that components of the present embodiment that are identical to those of the embodiments described above are given the same numerical references and their descriptions are omitted.

In the semiconductor device 106 according to the fifth embodiment as is illustrated by FIG. 14, the optical transmitter 48 and a driver 108 are connected to first, second, and third metal films 42b, 42c, and 42d formed on the substrate 42 via bumps 50 and 110.

The second and third metal films 42c and 42d are connected to the solder balls 58 via holes 112 and 114. Also, lenses 116 are fit into the substrate 42.

The optical transmitter 48 is mounted so that the light emitting side faces downward and is fixed to a mount position at which the laser diodes (LD) 48a face the lenses 116. Accordingly, in fixing the optical transmitter 48 to the substrate 42, when the optical axes of the laser diodes (LD) 48a of the optical transmitter 48 corresponds to the optical axes of the lenses 116, an ultrasonic wave is propagated so that the bumps 50 are fixed to the first and second metal films 42b and 42c of the substrate 42.

Then, the transparent resin material 52 is inserted between the optical transmitter 48 and the substrate 42. Then, a case 118 and external terminals are fixed to the substrate 42, and the socket 60 is fixed to a circuit substrate (not shown) to which the solder balls 58 of the substrate 42 are connected.

It is noted that in above description of the preferred embodiments, electro-photo conversion modules are illustrated as examples of a semiconductor device according to the present invention; however, the present invention is not limited to these embodiments, and for example, an optical receiver may be implemented instead of the optical transmitter so as to realize application of the present invention to a photo-electro conversion module.

The present application is based on and claims the benefit of the earlier filing date of Japanese Patent Application No.2003-68178 filed on Mar. 13, 2003, the entire contents of which are hereby incorporated by reference.

What is claimed is:

1. A semiconductor device comprising:
a semiconductor element that performs at least one of photo-electro conversion and electro-photo conversion;
a substrate on which the semiconductor element is mounted;
an optical component that controls at least one of light incident on the semiconductor element and light emitted from the semiconductor element; and
a bump that fixes the optical component to the substrate.

2. The semiconductor device as claimed in claim 1, wherein the optical component corresponds to a lens.

3. The semiconductor device as claimed in claim 1, wherein the bump corresponds to a gold bump.

4. The semiconductor device as claimed in claim 3, further comprising:
a first metal film that is formed on the substrate at a connection point between the bump and the substrate; and
a second metal film that is formed on the optical component at a connection point between the bump and the optical component.

5. The semiconductor device as claimed in claim 1, wherein a case that is adapted to accommodate an optical fiber is mounted on the substrate.

6. The semiconductor device as claimed in claim 1, further comprising:
a first alignment mark that is formed on the substrate; and
a second alignment mark that is formed on the optical component.

7. A semiconductor device comprising:
a semiconductor element that performs at least one of photo-electro conversion and electro-photo conversion;
a substrate on which the semiconductor element is mounted;
an optical component that controls at least one of light incident on the semiconductor element and light emitted from the semiconductor element; and
a bump that fixes the optical component to the semiconductor element.

8. The semiconductor device as claimed in claim 7, wherein the optical component corresponds to a lens.

9. The semiconductor device as claimed in claim 7, wherein the bump corresponds to a gold bump.

10. The semiconductor device as claimed in claim 9, further comprising:
a first metal film that is formed on the semiconductor element at a connection point between the bump and the semiconductor element; and
a second metal film that is formed on the optical component at a connection point between the bump and the optical component.

11. The semiconductor device as claimed in claim 7, wherein a case that is adapted to accommodate an optical fiber is mounted on the substrate.

12. The semiconductor device as claimed in claim 7, further comprising:
a first alignment mark that is formed on the semiconductor element; and
a second alignment mark that is formed on the optical component.

13. A method of manufacturing a semiconductor device that includes a substrate on which a semiconductor element that performs at least one of photo-electro conversion and electro-photo conversion is mounted, and an optical component that controls at least one of light incident on the semiconductor element and light emitted from the semiconductor element, the method comprising:
an optical component mounting step of mounting the optical component on the substrate implementing the semiconductor element, said optical component mounting step including:
forming a first alignment mark and a first metal film on the substrate;
forming a second alignment mark and a second metal film on the optical component;
placing a bump on one of the first metal film and the second metal film;
positioning the optical component to a mount position on the substrate based on the first alignment mark and the second alignment mark; and
fixing the optical component to the substrate by connecting the bump with the first metal film and the second metal film using an ultrasonic wave.

14. A method of manufacturing a semiconductor device that includes a semiconductor element that performs at least one of photo-electro conversion and electro-photo conversion, and an optical component that controls at least one of light incident on the semiconductor element and light emitted from the semiconductor element, the method comprising:
an optical component mounting step of mounting the optical component on the semiconductor element, said optical component mounting step including:
forming a first alignment mark and a first metal film on the semiconductor element;
forming a second alignment mark and a second metal film on the optical component;
placing a bump on one of the first metal film and the second metal film;
positioning the optical component to a mount position on the semiconductor element based on the first alignment mark and the second alignment mark; and
fixing the optical component to the semiconductor element by connecting the bump with the first metal film and the second metal film using an ultrasonic wave.
